(19) United States
(12) Patent Application Publication
(10) Pub. No.: US 2021/0320406 A1
(43) Pub. Date: Oct. 14, 2021

(54) ANTENNA SYSTEM AND ELECTRONIC DEVICE UTILIZING ANTENNA SYSTEM

(71) Applicants: XBRIGHT TECHNOLOGY CO., LTD., Hsinchu County (TW); Zhuo Cheng Electronics., LTD, New Taipei City (TW)

(72) Inventors: CHIEN-HUNG CHEN, Hsinchu County (TW); CHIH-HSIN WU, New Taipei City (TW); YU-YUAN GUO, Hsinchu County (TW)

(21) Appl. No.: 16/989,898

(22) Filed: Aug. 11, 2020

(30) Foreign Application Priority Data
Apr. 8, 2020 (TW) 109204077

(51) Int. Cl. H01Q 1/52; H01Q 21/06; H01Q 1/22; H01Q 9/04

(52) U.S. Cl. CPC H01Q 1/52; H01Q 21/062; H01Q 9/0421; H01Q 1/2291; H01Q 21/065

(57) ABSTRACT

An antenna system and an electronic device are provided. The antenna system includes a first substrate, a first antenna group, and a second antenna group. The first antenna group includes four first antennas that are disposed on a peripheral area of the first substrate. The second antenna group includes four second antennas that are disposed in an array on a second substrate. The four second antennas of the second antenna group are disposed above a central area of the first substrate. The central area of the first substrate has a recess. The second substrate is disposed above the recess. A first predetermined distance is defined between a bottom of the second substrate and the recess of the first substrate. A second predetermined distance is defined between the second substrate and the first substrate. The first predetermined distance is greater than the second predetermined distance.

### CROSS-REFERENCE TO RELATED PATENT APPLICATION

This application claims the benefits of priority to Taiwan Patent Application No. 109204077, filed on Apr. 8, 2020. The entire content of the above identified applications is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna system and an electronic device utilizing the antenna system, and more particularly to an antenna system with high isolation and an electronic device utilizing the antenna system with high isolation.

### BACKGROUND OF THE DISCLOSURE

Multi-User Multiple-Input Multiple-Output (MU-MIMO) is a technology that allows wireless routers and gateway devices to communicate with a plurality of terminal devices simultaneously, and one of the most crucial characteristics of the IEEE 802.11ax (Wi-Fi 6) standard. Although the MU-MIMO technology utilizes a plurality of antennas to simultaneously transfer data of a plurality of users, improvements regarding the strength of isolation of signal reception are still required.

Therefore, providing an antenna system with high isolation and an electronic device utilizing the antenna system with high isolation has become one of the most important issues in the industry.

### SUMMARY OF THE DISCLOSURE

In response to the above-referenced technical inadequacies, the present disclosure provides an antenna system.

In one aspect, the present disclosure provides an antenna system and an electronic device. The antenna system includes a first substrate, a first antenna group, and a second antenna group. The first antenna group includes four first antennas, and the four first antennas are disposed on a peripheral area of the first substrate. The second antenna group includes four second antennas, and the four second antennas are disposed in an array on a second substrate. The four second antennas of the second antenna group are disposed above a central area of the first substrate. The central area of the first substrate has a recess. The second substrate is disposed above the recess. A first predetermined distance is defined between a bottom of the second substrate and the recess of the first substrate. A second predetermined distance is defined between the second substrate and the first substrate. The first predetermined distance is greater than the second predetermined distance.

In another aspect, the present disclosure provides an electronic device. The electronic device includes a casing, a radio frequency (RF) controller, and an antenna system. The casing includes an upper casing unit and a lower casing unit. The upper casing unit and the lower casing unit cooperatively form an accommodating space. The antenna system is disposed in the accommodating space. The antenna system includes a first substrate, a first antenna group, and a second antenna group. The first antenna group includes four first antennas. The four first antennas are disposed on a peripheral area of the first substrate. The second antenna group includes four second antennas. The four second antennas are disposed in an array on a second substrate. The four antennas of the second antenna group are disposed above a central area of the first substrate. The central area of the first substrate has a recess. The second substrate is disposed above the recess. A first predetermined distance is defined between a bottom of the second substrate and the recess of the first substrate. A second predetermined distance is defined between the second substrate and the first substrate.

In yet another aspect, the present disclosure provides an antenna system. The antenna system includes a first substrate, a first antenna group, a second antenna group, and an auxiliary antenna.

The first antenna group includes four first antennas. The four first antennas are disposed on a peripheral area of the first substrate. The four first antennas transmit and receive a plurality of first communication signals in a first frequency band and a plurality of second communication signals in a second frequency band.

The second antenna group includes four second antennas. The four second antennas are disposed in an array on a second substrate. The four second antennas of the second antenna group are disposed above a central area of the first substrate, and the four second antennas transmit and receive the plurality of second communication signals in the second frequency band.

The auxiliary antenna is disposed between two of the four first antennas, and the auxiliary antenna transmits and receives the plurality of first communication signals in the first frequency band and the plurality of second communication signals in the second frequency band.

The central area of the first substrate has a recess, the second substrate is disposed above the recess, a first predetermined distance is defined between a bottom of the second substrate and the recess of the first substrate, and a second predetermined distance is defined between the second substrate and the first substrate.

One of the advantages of the present disclosure is that the antenna system and the electronic device include two groups of Multiple-Input Multiple-Output (MIMO) antennas disposed at an inner and an outer area of a grounding plate. In addition, the MIMO antenna group on the inner area is disposed above the grounding plate in a predetermined distance to effectively enhance efficiency of the second (MIMO) antenna group when receiving 5G frequency band. Moreover, the antenna system of the present disclosure utilizes an auxiliary antenna that is disposed between two of the antennas on the peripheral area to detect Wi-Fi signals from the surroundings.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic view of an electronic device in a first embodiment of the present disclosure.

FIG. 2 is an exploded view of the electronic device of FIG. 1.

FIG. 3 is a top view of an antenna system of FIG. 2.

FIG. 4 is a side view of the antenna system of FIG. 2.

FIG. 5 is a schematic view of a second antenna group of FIG. 2.

FIG. 6 is a schematic view of one of second antennas of the second antenna group of FIG. 5.

FIG. 7 is an exploded view of the electronic device in a second embodiment of the present disclosure.

FIG. 8 is a schematic view of the antenna system of FIG. 7.

FIG. 9 is a top view of the antenna system of FIG. 7.

FIG. 10 is a top view of the second antennas of FIG. 7.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

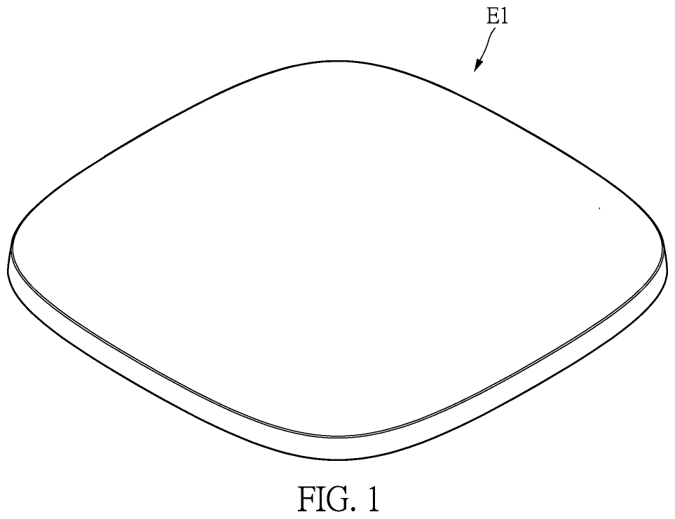

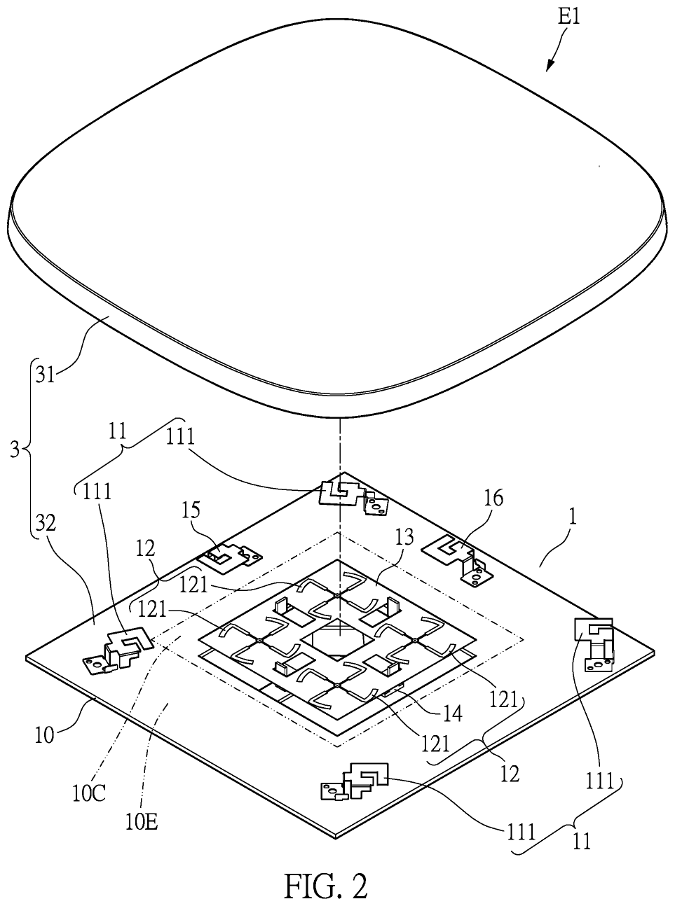

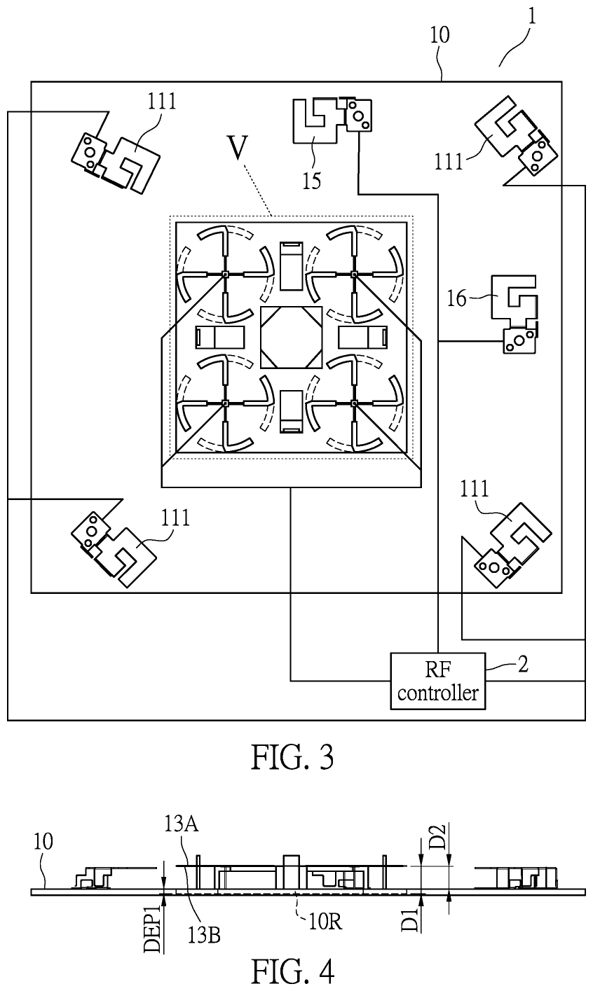

Reference is made to FIG. 1, which is a schematic view of an electronic device in a first embodiment of the present disclosure. Reference is made to FIG. 2, which is an exploded view of the electronic device of FIG. 1. Reference is made to FIG. 3, which is a top view of an antenna system of FIG. 2. Reference is made to FIG. 4, which is a side view of the antenna system of FIG. 2.

As shown in FIG. 1, an electronic device E1 includes an antenna system 1, a radio frequency (RF) controller 2, and a casing 3. The electronic device E1 is a wireless router or a gateway device. The RF controller 2 can be a communication circuit that includes a plurality of communication protocols, such as a Wi-Fi communication circuit and a Bluetooth® communication circuit. In addition, the RF controller can also be an RF chip, such as a Wi-Fi RF chip and a Bluetooth® RF chip.

The casing 3 includes an upper casing unit 31 and a lower casing unit 32. The upper casing unit 31 and the lower casing unit 32 cooperatively form an accommodating space, so as to accommodate the antenna system 1 and the RF controller 2. In other embodiments, the RF controller 2 can be disposed outside the casing 3.

The antenna system 1 includes a first substrate 10, a first antenna group 11, a second antenna group 12, a second substrate 13, and a supportive frame 14.

The first antenna group 11 includes four first antennas 111. The four first antennas 111 are disposed on a peripheral area 10E of the first substrate 10. In this embodiment, the four first antennas 111 are radially disposed on the peripheral area 10E of the first substrate 10. The antenna patterns of the four first antennas 111 are distributed to jointly cover a 360° area around the electronic device E1.

Referring to FIG. 2, the second antenna group 12 includes four second antennas 121. The four second antennas 121 are disposed in an array on the second substrate 13. The four second antennas 121 of the second antenna group 12 are disposed above a central area 10C of the first substrate 10. The peripheral area 10E of the first substrate 10 is surroundingly disposed around the perimeter of the central area 10C. The central area 10C of the first substrate 10 has a recess 10R. The second substrate 13 is correspondingly disposed above the recess 10R.

Referring to FIG. 3 and FIG. 4, a first predetermined distance D1 is defined between a bottom of the second substrate 13 and the recess 10R of the first substrate 10. A second predetermined distance D2 is defined between the second substrate 13 and the first substrate 10. The first predetermined distance D1 is greater than the second predetermined distance D2. In this embodiment, the first predetermined distance D1 is 8.9 mm, and the second predetermined distance D2 is 7.4 mm. A distance (not shown in the figures) between the four first antennas 111 and the first substrate 10 is 8 mm.

The antenna system 1 further includes an auxiliary antenna 15. The auxiliary antenna 15 is disposed between two of the four first antennas 111. Moreover, the antenna system 1 further includes a Bluetooth® antenna 16. The Bluetooth® antenna 16 is disposed between two of the four first antennas 111. The auxiliary antenna 15 and the Bluetooth® antenna 16 are not disposed between the same two of the four first antennas 111. That is to say, the auxiliary antenna 15 and the Bluetooth® antenna 16 are respectively disposed on different areas.

As shown in FIG. 2 and FIG. 3, the auxiliary antenna 15 and the Bluetooth® antenna 16 are disposed on two sides of the first substrate 10 that are adjacent to each other. In other embodiments, the auxiliary antenna 15 and the Bluetooth® antenna 16 can be disposed on two sides of the first substrate 10 that are opposite to each other.

In this embodiment, a shape of the recess 10R is identical to a shape of the second substrate 13. The recess 10R has a first depth DPE1. The first depth DEP1 is less than a thickness of the first substrate 10. In this embodiment, the recess 10R has a shape of a square. In other embodiments, the recess 10R can be in a shape of a rectangle, a circle, or an oval. The first depth DEP1 is 1.5 mm.

Each of the four first antennas 111 is a planar inverted F antenna, and each of the four second antennas 121 is a dipole antenna.

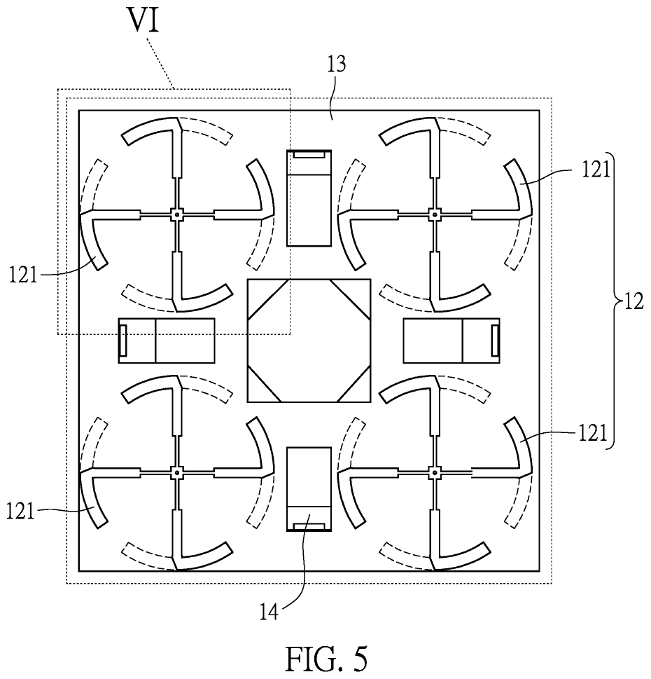

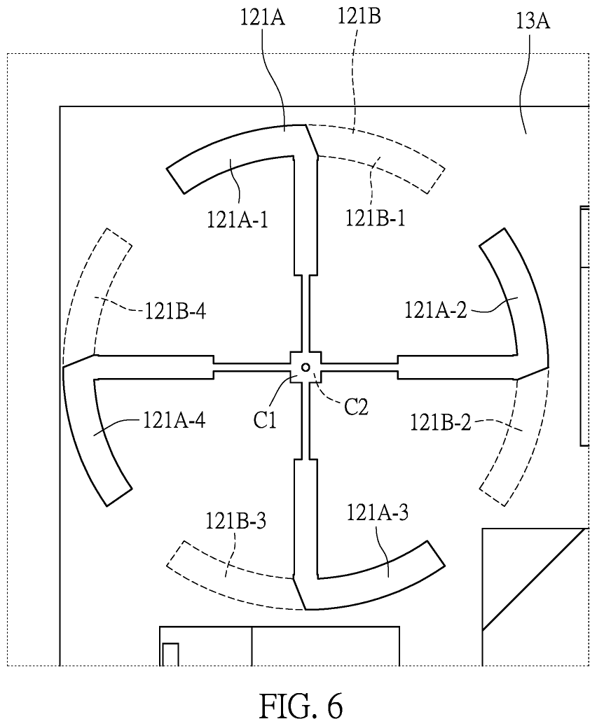

Reference is made to FIG. 5, which is a schematic view of a second antenna group of FIG. 2. Reference is made to FIG. 6, which is a schematic view of one of second antennas of the second antenna group of FIG. 5.

Each of the four second antennas 121 includes a first resonance layer 121A and a second resonance layer 121B. The first resonance layer 121A and the second resonance layer 121B of each of the four second antennas 121 are respectively disposed on a first surface 13A and a second surface 13B of the second substrate 13. The first surface 13A and the second surface 13B of the second substrate 13 are disposed corresponding to each other.

The first resonance layer 121A includes four first resonance units 121A-1 to 121A-4, and the second resonance layer 121B also includes four second resonance units 121B-1 to 121B-4.

The four first resonance units 121A-1 to 121A-4 are electronically connected to a connecting point C1 of the first surface 13A and the four second resonance units 121B-1 to 121B-4 are electrically connected a second connecting point C2 of the second surface 13B. The first connecting point C1 is electrically connected to the RF controller 2, and the second connecting point C2 is electrically connected to a ground electrical potential.

In this embodiment, the four first resonance units 121A-1 to 121A-4 of the first resonance layer 121A are disposed in a form of the spiral arms of the Milky Way galaxy. The four first resonance units 121A-1 to 121A-4 respectively extend from the first connecting point C1 for a linear distance, and ends of the four first resonance units 121A-1 to 121A-4 extend along the side in an arced shape.

The four second resonance units 121B-1 to 121B-4 are also disposed in a form of the spiral arms of the Milky Way galaxy. The four second resonance units 121B-1 to 121B-4 also respectively extend from the second connecting point C2 for a linear distance, and ends of the four second resonance units 121B-1 to 121B-4 also extend along the side in the arced shape. However, it is worth mentioning that a direction toward which the ends of the four first resonance units 121A-1 to 121A-4 extend and another direction toward which the ends of the four second resonance units 121B-1 to 121B-4 extend are opposite to each other. As shown in the FIG. 5 and FIG. 6, the four first resonance units 121A-1 to 121A-4 and the four second resonance units 121B-1 to 121B-4 are disposed in a manner of four T-shapes in four directions that are perpendicular to one another.

In this embodiment, each of the four first antennas 111 and each of the four second antennas 121 are electrically connected to a coaxial cable, so as to be electrically connected to the RF controller 2. Communication signals received by the four first antennas 111 and the four second antennas 121 are transmitted to the RF controller 2 to conduct signal processing. The communication signals that are processed and that are received from other devices are transmitted to the four first antennas 111 and the four second antennas 121 through the coaxial cable to be transmitted.

Each of the four first antennas 111 of the first antenna group 11 is a first Multiple-Input Multiple-Output (MIMO) antenna, and each of the four second antennas 121 of the second antenna group 12 is a second MIMO antenna.

The four first antennas 111 transmit and receive a plurality of first communication signals in a first frequency band and a plurality of second communication signals in a second frequency band. The first frequency band is a 2.4G Wi-Fi frequency band and the second frequency band is a 5G Wi-Fi frequency band. That is to say, the four first antennas 111 of the first antenna group 11 are utilized to transmit and receive the 2.4G Wi-Fi frequency communication signals and the 5G Wi-Fi frequency communication signals. Similarly, the auxiliary antenna 15 transmits and receives the plurality of first communication signals in the first frequency band and the plurality of second communication signals in the second frequency band. The first frequency band is the 2.4G Wi-Fi frequency band and the second frequency band is the 5G Wi-Fi frequency band.

The four second antennas 121 transmit and receive the plurality of second communication signals in the second frequency band. The second frequency band is the afore-mentioned 5G Wi-Fi frequency band. That is to say, the four second antennas 121 of the second antenna group 12 are utilized to transmit and receive the 5G Wi-Fi frequency communication signals.

According to the abovementioned disposal of the antennas, the antennas that are disposed on the peripheral area 10E of the first substrate 10, including the four first antennas 111 and the auxiliary antenna 15, are capable of transmitting and receiving communication signals in both of the afore-mentioned frequency bands. The antennas that are disposed on the central area 10C of the first substrate 10, including the four second antennas 121, transmit and receive communication signals in a single frequency band. Moreover, the second substrate 13 is disposed above the central area 10C of the first substrate 10. Furthermore, the Bluetooth® antenna 16 transmits and receives the communication signals in the 2.4G Bluetooth® frequency band. In this embodiment, the Bluetooth® antenna 16 is utilized to transmit and receive Bluetooth® communication signals from conventional Bluetooth® devices and Internet of Things (IoT) Bluetooth® communication signals from IoT devices.

The supportive frame 14 is disposed on the first substrate 10. The second substrate 13 is disposed on the supportive frame 14. In this embodiment, the supportive frame is a frame composed of an insulated material, e.g., plastic.

In this embodiment, the first substrate 10 is a metal board and the second substrate 13 is a printed circuit board. The first substrate 10 is utilized to be a grounding plate.

### Second Embodiment

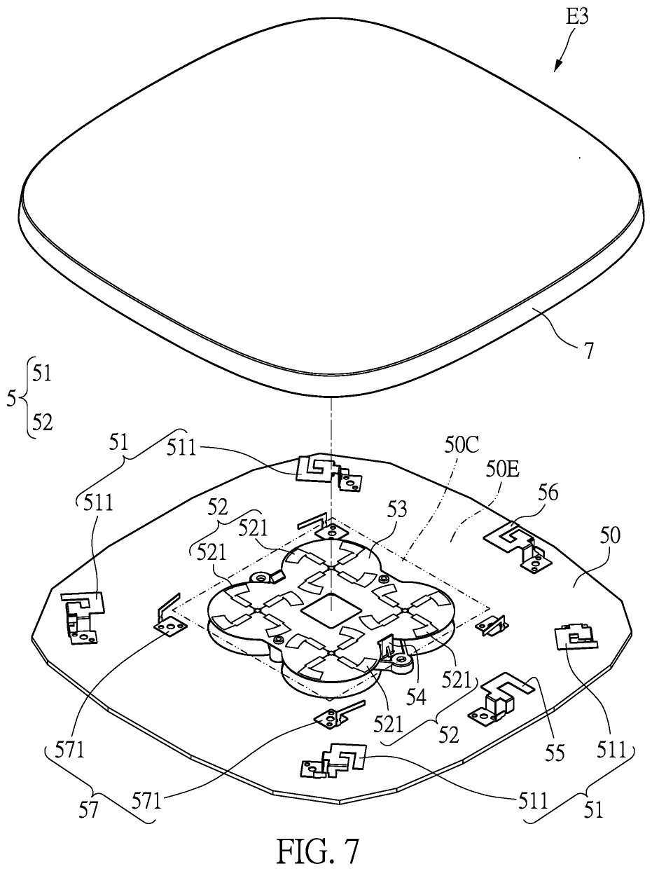

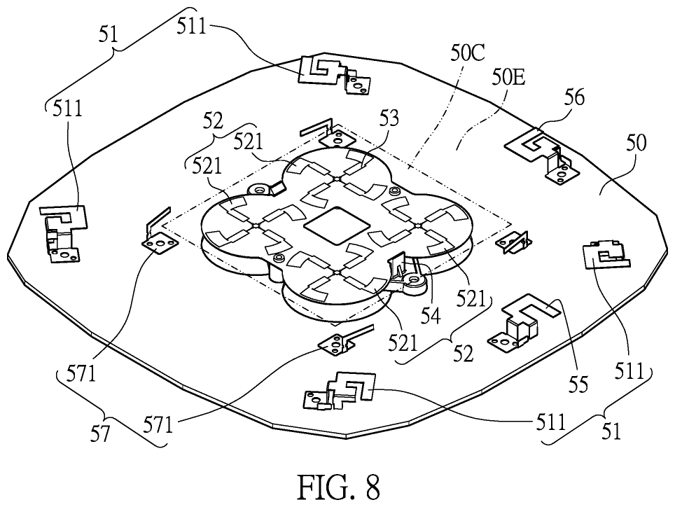

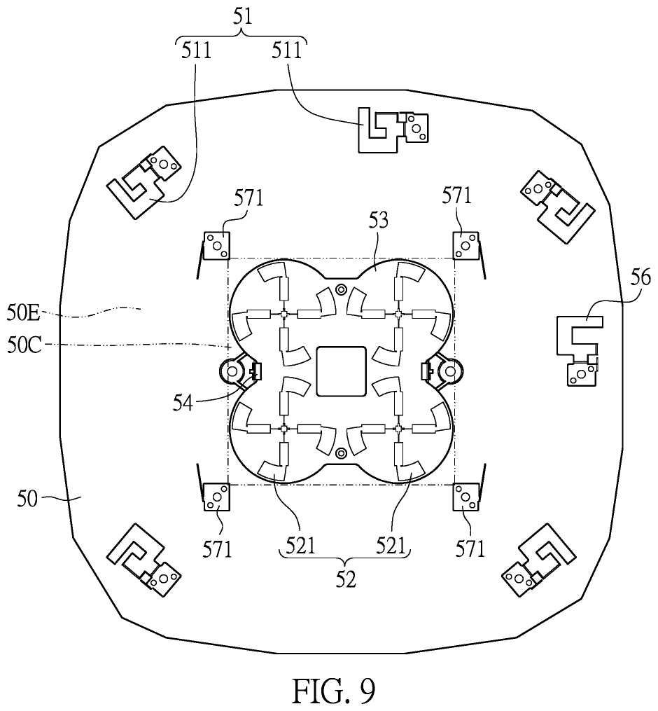

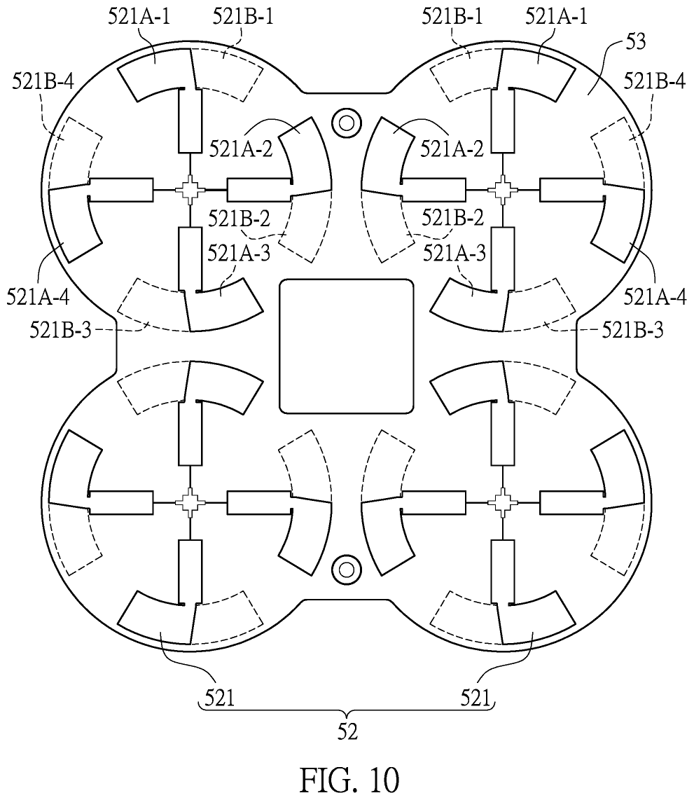

Reference is made to FIG. 7, which is an exploded view of the electronic device in a second embodiment of the present disclosure. Reference is made to FIG. 8, which is a schematic view of the antenna system of FIG. 7. Reference is made to FIG. 9, which is a top view of the antenna system of FIG. 7. Reference is made to FIG. 10, which is a top view of the second antennas of FIG. 7.

As shown in FIG. 7, an electronic device E3 includes an antenna system 5, a radio frequency (RF) controller (not shown in the figures), and a casing 7. The electronic device E3 is a wireless router or a gateway device. The RF controller (not shown in the figures) can be a communication circuit that includes a plurality of communication protocols, such as a Wi-Fi communication circuit and a Bluetooth® communication circuit. In addition, the RF controller (not shown in the figures) can also be an RF chip, such as a Wi-Fi RF chip and a Bluetooth® RF chip.

The casing 7 includes an upper casing unit (not shown in the figures) and a lower casing unit (not shown in the figures). The upper casing unit (not shown in the figures) and the lower casing unit (not shown in the figures) cooperatively form an accommodating space, so as to accommodate the antenna system 5 and the RF controller (not shown in the figures). In other embodiments, the RF controller (not shown in the figures) can be disposed outside the casing 7.

The antenna system 5 includes a first substrate 50, a first antenna group 51, a second antenna group 52, a second substrate 53, a supportive frame 54, and an isolation element group 57.

The first antenna group 51 includes four first antennas 511. The four first antennas 511 are disposed on a peripheral area 50E of the first substrate 50. In this embodiment, the four first antennas 511 are radially disposed on the peripheral area 50E of the first substrate 50. The antenna patterns of the four first antennas 511 are distributed to jointly cover a 360° area around the electronic device E3.

Referring to FIG. 8, the second antenna group 52 includes four second antennas 521. The four second antennas 521 are disposed in an array on the second substrate 53. The four second antennas 521 of the second antenna group 52 are disposed above a central area 50C of the first substrate 50. The peripheral area 50E of the first substrate 50 is surroundingly disposed around the perimeter of the central area 50C. The central area 50C of the first substrate 50 has a recess 50R. The second substrate 53 is correspondingly disposed above the recess 50R.

The isolation element group 57 includes four isolation elements 571. Each of the four isolation elements 571 is respectively disposed between one of the four first antennas 511 and one of the four second antennas 521 that are correspondingly disposed. That is to say, one of the four isolation elements 571 is disposed between each of the four first antennas 511 and each of the correspondingly disposed four second antennas 521. Each of the four isolation elements 571 is utilized to strengthen isolation of each of the four first antennas 511 and each of the correspondingly disposed four second antennas 521 when receiving signals in different frequency bands.

In this embodiment, a first predetermined distance (not shown in the figures) is defined between a bottom of the second substrate 53 and the recess 50R of the first substrate 50. A second predetermined distance (not shown in the figures) is defined between the second substrate 53 and the first substrate 50. Similar to the first embodiment, the first predetermined distance (not shown in the figures) is greater than the second predetermined distance (not shown in the figures). In addition, similarly, the first predetermined distance (not shown in the figures) is 8.9 mm, and the second predetermined distance (not shown in the figures) is 7.4 mm. A distance (not shown in the figures) between the four first antennas 511 and the first substrate 50 is 8 mm.

The antenna system 5 further includes an auxiliary antenna 55. The auxiliary antenna 55 is disposed between two of the four first antennas 511. Moreover, the antenna system 5 further includes a Bluetooth® antenna 56. The Bluetooth® antenna 56 is disposed between two of the four first antennas 511. The auxiliary antenna 55 and the Bluetooth® antenna 56 are not disposed between the same two of the four first antennas 511. That is to say, the auxiliary antenna 55 and the Bluetooth® antenna 56 are respectively disposed on different areas.

As shown in FIG. 7 and FIG. 8, the auxiliary antenna 55 and the Bluetooth® antenna 56 are disposed on two sides of the first substrate 50 that are adjacent to each other. In other embodiments, the auxiliary antenna 55 and the Bluetooth® antenna 56 can be disposed on two sides of the first substrate 50 that are opposite to each other.

In this embodiment, a shape of the recess 50R is identical to a shape of the second substrate 53. The recess 50R has a first depth (not shown in the figures). The first depth (not shown in the figures) is less than a thickness of the first substrate 50. In this embodiment, the recess 50R has a shape of a four leaf clover. In other embodiments, the recess 50R can be in a shape of a rectangle, a circle, or an oval. Moreover, similar to the first embodiment, the first depth (not shown in the figures) is 1.5 mm.

Each of the four first antennas 511 is a planar inverted F antenna, and each of the four second antennas 521 is a dipole antenna.

Reference is made to FIG. 9 and FIG. 10, each of the four second antennas 521 includes a first resonance layer 521A and a second resonance layer 521B. The first resonance layer 521A and the second resonance layer 521B of each of the four second antennas 521 are respectively disposed on a first surface 53A and a second surface 53B of the second substrate 53. The first surface 53A and the second surface 53B of the second substrate 53 are disposed corresponding to each other.

The first resonance layer 521A includes four first resonance units 521A-1 to 521A-4, and the second resonance layer 521B also includes four second resonance units 521B-1 to 521B-4.

The four first resonance units 521A-1 to 521A-4 are electronically connected to a connecting point C1 of the first surface 53A and the four second resonance units 121B-1 to 121B-4 are electrically connected a second connecting point C2 of the second surface 53B. The first connecting point C1 is electrically connected to the RF controller (not shown in the figures), and the second connecting point C2 is electrically connected to a ground electrical potential.

In this embodiment, the four first resonance units 521A-1 to 521A-4 of the first resonance layer 521A are disposed in a form of the spiral arms of the Milky Way galaxy. The four first resonance units 521A-1 to 521A-4 respectively extend from the first connecting point C1 for a linear distance, and ends of the four first resonance units 521A-1 to 521A-4 extend along the side in an arced shape.

The four second resonance units 521B-1 to 521B-4 are also disposed in a form of the spiral arms of the Milky Way galaxy. The four second resonance units 521B-1 to 521B-4 also respectively extend from the second connecting point C2 for a linear distance, and ends of the four second resonance units 521B-1 to 521B-4 also extend along the side in the arced shape. However, it is worth mentioning that a direction toward which the ends of the four first resonance units 521A-1 to 521A-4 extend along the side and another direction toward which the ends of the four second resonance units 521B-1 to 521B-4 extend along the side are opposite to each other. As shown in the FIG. 5 and FIG. 6, the four first resonance units 521A-1 to 521A-4 and the four second resonance units 521B-1 to 521B-4 are disposed in a manner of four T-shapes in four directions that are perpendicular to one another.

However, unlike the first embodiment, in this embodiment, the four first resonance units 521A-1 to 521A-4 of any two of the four second antennas 521 that are adjacent to each other have opposite rotation directions.

In this embodiment, each of the four first antennas 511 and each of the four second antennas 521 are electrically connected to a coaxial cable, so as to be electrically connected to the RF controller (not shown in the figures). Communication signals received by the four first antennas 511 and the four second antennas 521 are transmitted to the RF controller (not shown in the figures) to conduct signal processing. The communication signals that are processed and that are received from other devices are transmitted to the four first antennas 511 and the four second antennas 521 through the coaxial cable to be transmitted.

Each of the four first antennas 511 of the first antenna group 51 is a first MIMO antenna, and each of the four second antennas 521 is a second MIMO antenna.

The four first antennas 511 transmit and receive a plurality of first communication signals in a first frequency band and a plurality of second communication signals in a second frequency band. The first frequency band is a 2.4G Wi-Fi frequency band, and the second frequency band is a 5G to 7G Wi-Fi frequency band. That is to say, the four first antennas 511 of the first antenna group 51 are utilized to transmit and receive the 2.4G Wi-Fi frequency communication signals and the 5G to 7G Wi-Fi frequency communication signals.

Similarly, the auxiliary antenna 55 transmits and receives the plurality of first communication signals in the first frequency band, and the plurality of second communication signals in the second frequency band. The first frequency band is the 2.4G Wi-Fi frequency band, and the second frequency band is the 5G to 7G Wi-Fi frequency band.

The four second antennas 521 transmit and receive the plurality of second communication signals in the second frequency band. The second frequency band is the afore-mentioned 5G to 7G Wi-Fi frequency band. That is to say, the four second antennas 521 of the second antenna group 52 are utilized to transmit and receive the 5G to 7G Wi-Fi frequency communication signals.

According to the abovementioned disposal of the antennas, the antennas that are disposed on the peripheral area 50E of the first substrate 50, including the four first antennas 511 and the auxiliary antenna 55, are capable of transmitting and receiving communication signals in both of the afore-mentioned frequency bands. The antennas that are disposed on the central area 50C of the first substrate 50, including the four second antennas 521, transmit and receive communication signals in a single frequency band. Moreover, the second substrate 53 is disposed above the central area 50C of the first substrate 50. Furthermore, the Bluetooth® antenna 56 transmits and receives the communication signals in the 2.4G Bluetooth® frequency band. In this embodiment, the Bluetooth® antenna 56 is utilized to transmit and receive Bluetooth® communication signals from conventional Bluetooth® devices and Internet of Things (IoT) Bluetooth® communication signals from IoT devices. Furthermore, the four isolation elements 571 of the isolation element group 57 can enhance isolation of the first antenna group 51 and the second antenna group 52 when receiving signals.

The supportive frame 54 is disposed on the first substrate 50. The second substrate 53 is disposed on the supportive frame 54. In this embodiment, the supportive frame is a frame composed of an insulated material, e.g., plastic.

In this embodiment, the first substrate 50 is a metal board and the second substrate 53 is a printed circuit board. T the first substrate 50 is utilized to be a grounding plate.

One of the advantages of the present disclosure is that the antenna system and the electronic device are disposed with two groups of MIMO antennas at an inner and an outer area of a grounding plate, such that the isolation of the two MIMO antenna groups is effectively enhanced when receiving 5G frequency band.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna system, comprising:
a first substrate;
a first antenna group including four first antennas, the four first antennas being disposed on a peripheral area of the first substrate; and
a second antenna group including four second antennas, the four second antennas being disposed in an array on a second substrate, wherein the four second antennas of the second antenna group are disposed above a central area of the first substrate;
wherein the central area of the first substrate has a recess, the second substrate is disposed above the recess, a first predetermined distance is defined between a bottom of the second substrate and the recess of the first substrate, a second predetermined distance is defined between the second substrate and the first substrate, and the first predetermined distance is greater than the second predetermined distance.

2. The antenna system according to claim 1, further comprising an auxiliary antenna disposed between two of the four first antennas.

3. The antenna system according to claim 2, further comprising a Bluetooth® antenna disposed between two of the four first antennas, wherein the auxiliary antenna and the Bluetooth® antenna are not disposed on the same area.

4. The antenna system according to claim 1, wherein the recess has a shape identical to a shape of the second substrate, and the recess has a first depth.

5. The antenna system according to claim 1, wherein each of the four first antennas is a planar inverted F antenna, and each of the four second antennas is a dipole antenna.

6. The antenna system according to claim 5, wherein each of the four first antennas is a first Multiple-Input Multiple-Output (MIMO) antenna, and each of the four second antennas is a second MIMO antenna.

7. The antenna system according to claim 1, wherein each of the second antennas includes a first resonance layer and a second resonance layer, the first resonance layer and the second resonance layer of the second antenna are respectively disposed on a first surface and a second surface of the second substrate, the first surface and the second surface are disposed corresponding to each other, the first resonance layer includes four first resonance units, and the second resonance layer includes four second resonance units, and wherein the four first resonance units are electrically connected to a first connecting point of the first surface, and the four second resonance units are electrically connected to a second connecting point of the second surface.

8. The antenna system according to claim 1, further comprising a supportive frame disposed on the first substrate, wherein the second substrate is disposed on the supportive frame.

9. An electronic device, comprising:
a casing, including an upper casing unit and a lower casing unit, the upper casing unit and the lower casing unit cooperatively form an accommodating space;
a radio frequency controller; and
an antenna system disposed in the accommodating space, the antenna system including:
a first substrate;
a first antenna group including four first antennas, the four first antennas being disposed on a peripheral area of the first substrate; and
a second antenna group including four second antennas, the four second antennas being disposed in an array on a second substrate, wherein the four antennas of the second antenna group are disposed above a central area of the first substrate;
wherein the central area of the first substrate has a recess, the second substrate is disposed above the recess, a first predetermined distance is defined between a bottom of the second substrate and the recess of the first substrate, a second predetermined distance is defined between the second substrate and the first substrate, and the first predetermined distance is greater than the second predetermined distance.

10. An antenna system, comprising:
a first substrate;
a first antenna group including four first antennas, the four first antennas being disposed on a peripheral area of the first substrate, wherein the four first antennas transmit and receive a plurality of first communication signals in a first frequency band and a plurality of second communication signals in a second frequency band;
a second antenna group including four second antennas, the four second antennas being disposed in an array on a second substrate, wherein the four second antennas of the second antenna group are disposed above a central area of the first substrate, and the four second antennas transmit and receive the plurality of second communication signals in the second frequency band;
an auxiliary antenna disposed between two of the four first antennas, the auxiliary antenna transmitting and receiving the plurality of first communication signals in the first frequency band and the plurality of second communication signals in the second frequency band; and
a Bluetooth® antenna disposed between two of the four first antennas, wherein the auxiliary antenna and the Bluetooth® antenna are disposed on two sides of the first substrate that are adjacent to or opposite to each other;
wherein the central area of the first substrate has a recess, the second substrate is disposed above the recess, a first predetermined distance is defined between a bottom of the second substrate and the recess of the first substrate, a second predetermined distance is defined between the second substrate and the first substrate, and the first predetermined distance is greater than the second predetermined distance.

11. An antenna system, comprising:
a first substrate;
a first antenna group including four first antennas, the four first antennas being disposed on a peripheral area of the first substrate;
a second antenna group including four second antennas, the four second antennas being disposed in an array on a second substrate, wherein the four second antennas of the second antenna group are disposed above a central area of the first substrate; and
an isolation element group including four isolation elements, each of the four isolation elements being disposed between one of the four first antennas and one of the four second antennas that are correspondingly disposed;
wherein the central area of the first substrate has a recess, the second substrate is disposed above the recess, a first predetermined distance is defined between a bottom of the second substrate and the recess of the first substrate, a second predetermined distance is defined between the second substrate and the first substrate, and the first predetermined distance is greater than the second predetermined distance.

12. The antenna system according to claim 11, further comprising an auxiliary antenna disposed between two of the four first antennas.

13. The antenna system according to claim 12, further comprising a Bluetooth® antenna disposed between two of the four first antennas, wherein the auxiliary antenna and the Bluetooth® antenna are not disposed on the same area.

14. The antenna system according to claim 11, wherein a shape of the recess is identical to a shape of the second substrate, and the recess has a first depth.

15. The antenna system according to claim 11, wherein each of the four first antennas is a planar inverted F antenna and each of the four second antennas is a dipole antenna.

16. The antenna system according to claim 15, wherein each of the four first antennas is a first MIMO antenna and each of the four second antennas is a second MIMO antenna.

17. The antenna system according to claim 11, wherein each of the second antennas includes a first resonance layer and a second resonance layer, the first resonance layer and the second resonance layer of the second antenna are respectively disposed on a first surface and a second surface of the second substrate, the first surface and the second surface are disposed corresponding to each other, the first resonance layer includes four first resonance units, and the second resonance layer includes four second resonance units, and wherein the four first resonance units are electrically connected to a first connecting point of the first surface, and the four second resonance units are electrically connected to a second connecting point of the second surface.

18. The antenna system according to claim 11, further comprising a supportive frame disposed on the first substrate, wherein the second substrate is disposed on the supportive frame.
